(19) United States
(12) Patent Application Publication
(10) Pub. No.: US 2009/0077615 A1
(43) Pub. Date: Mar. 19, 2009

(54) Security Policy Validation For Web Services

(76) Inventors: Hyen V. Chung, Round Rock, TX (US); Yuhichi Nakamura, Kanagawa-Ken (JP); Fumiko Satoh, Tokyo (JP)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/854,841

(22) Filed: Sep. 13, 2007

(51) Int. Cl. H04L 9/32

(52) U.S. Cl. 726/1

(57) ABSTRACT

Methods, apparatus, and products are disclosed for security policy validation for web services that include: transforming a security policy for a web service into a policy predicate logic representation; providing a profile predicate logic representation that represents one or more rules of a security policy profile; determining whether the security policy satisfies the security policy profile in dependence upon the policy predicate logic representation and the profile predicate logic representation; and notifying a user that the security policy is valid if the security policy satisfies the security policy profile

### CROSS-REFERENCE TO RELATED APPLICATION

This application is related to U.S. patent application Ser. No. 11/854,318, filed on Sep. 12, 2007.

### BACKGROUND OF THE INVENTION

1. Field of the Invention

The field of the invention is data processing, or, more specifically, methods, apparatus, and products for security policy validation for web services.

2. Description of Related Art

Many enterprises are currently undertaking development using the Service-Oriented Architecture (‘SOA’) because their business models are changing more frequently. SOA makes application development easier because technology-independent services can be coupled over intranets and via the Internet. As business models are changing more frequently, the underlying computing environments on which the applications are running are becoming more complex because computers can be networked using complicated topologies, including firewalls and intermediate servers. Consequently, the proper configuration of non-functional aspects such as security requires a fairly deep understanding of such complex environments.

In light of such developments, unifying security with the software engineering process from the beginning is important. Unfortunately, security is often considered as an afterthought in most actual developments in the sense that security is added after the functional requirements are implemented. It is well known, however, that correcting defects in the late stages of the design process greatly increases the costs of removal and repair of those defects.

More recently, the Service Component Architecture (‘SCA’) is being standardized as a component model for SOA. Intentions for non-functional requirements such as security and transactions are specified at an abstract level in SCA's Policy Framework, and these intentions are being mapped into concrete policies such as WS-SecurityPolicy. According to the SCA Policy Framework, software engineers should prepare in advance a collection of WS-SecurityPolicy documents so that policies are retrieved from the security intentions attached to the SCA components. Therefore, it is important to define valid policy documents for the SCA components from the beginning of the development process.

To guide the development of security policies, most enterprises have security guidelines in the form of security profiles that describe the format of Web services security messages. In addition, there also exist standard profiles on Web services security such as, for example, WS-I Basic Security Profile that also prescribes industry standard security message formats. In the current art, however, the process of determining whether a security policy comports with a security profile is a manual process fraught with error due to the complexity of SOA environments. As such, readers will appreciate room for improvement exists in security policy validation for web services.

### SUMMARY OF THE INVENTION

Methods, apparatus, and products are disclosed for security policy validation for web services that include: transforming a security policy for a web service into a policy predicate logic representation; providing a profile predicate logic representation that represents one or more rules of a security policy profile; determining whether the security policy satisfies the security policy profile in dependence upon the policy predicate logic representation and the profile predicate logic representation; and notifying a user that the security policy is valid if the security policy satisfies the security policy profile.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system capable of security policy validation for web services according to embodiments of the present invention.

FIG. 2 sets forth a line drawing illustrating exemplary security policies and security profiles useful in security policy validation for web services according to embodiments of the present invention.

FIG. 3 sets forth a flow chart illustrating an exemplary method of security policy validation for web services according to embodiments of the present invention.

FIG. 4 sets forth a flow chart illustrating a further exemplary method of security policy validation for web services according to embodiments of the present invention.

### DETAILED DESCRIPTION OF EXEMPLARY EMBODIMENTS

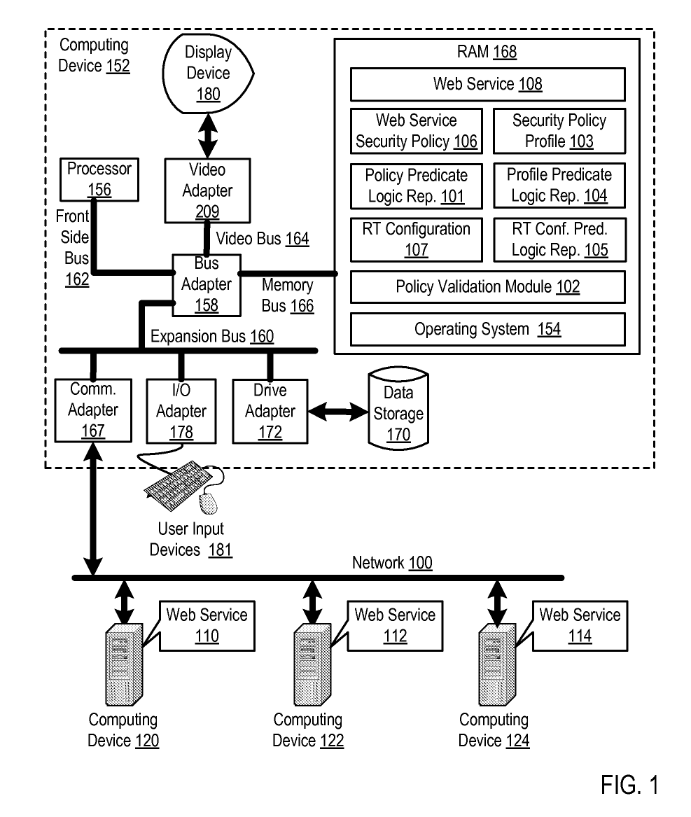

Exemplary methods, apparatus, and products for security policy validation for web services in accordance with the present invention are described with reference to the accompanying drawings, beginning with FIG. 1. FIG. 1 sets forth a functional block diagram of an exemplary system capable of security policy validation for web services according to embodiments of the present invention. The exemplary system of FIG. 1 includes several computing devices (152, 120, 122, 124) connected together for data communications through a network (100). Each computing device (152, 120, 122, 124) respectively has installed upon it a web service (108, 110, 112, 114). A web service is software designed to support interoperable machine-to-machine interaction over a network. Web services are frequently accessed through web application programming interfaces (‘API’s) over a network and executed on a remote system hosting the requested web service. The API for web services are typically described using the Web Services Description Language (‘WSDL’) and published by a service broker according to the Universal Description, Discovery, and Integration (‘UDDI’) protocol.

In the exemplary system of FIG. 1, the web services typically communicate through the exchange of eXtensible Markup Language (‘XML’)-based messages according to SOAP. SOAP is a platform and language independent protocol for exchanging XML-based messages over computer networks, normally using the Hypertext Transfer Protocol (‘HTTP’) or secure HTTP. SOAP forms the foundation layer of the web services stack, providing a basic messaging framework that more abstract layers can build on. There are several different types of messaging patterns in SOAP, but by far the most common is the Remote Procedure Call (‘RPC’) pattern, in which one web service (the client) sends a request message to another web service (the server), and the server immediately sends a response message to the client. In such a manner, SOAP is the successor of XML-RPC, which is a remote procedure call protocol that uses XML to encode its calls and HTTP as a transport mechanism.

A web service message implemented using SOAP is an ordinary XML document that contains the following elements:
A required Envelope element that identifies the XML document as a SOAP message;
An optional Header element that contains header information;
A required Body element that contains call and response information; and
An optional Fault element that provides information about errors that occurred while processing the message.

To secure the exchange of SOAP messages, web services typically utilize security tokens and other security mechanisms to protect the web service messages. One format for embedding security tokens and using other security features to protect web service messages is described in the WS-Security specification promulgated by the Organization for the Advancement of Structured Information Standards (‘OASIS’). The WS-Security specification describes how to attach digital signature and encryption headers to SOAP messages. In addition, WS-Security describes how to attach security tokens, including binary security tokens such as, for example, X.509 certificates and Kerberos tickets, to web service messages. Readers will note that a web service message that implements security protections is referred to as a ‘web service security message.’

In a web service security message, application data is embedded in the Body element, while security information is embedded in the Header element. For example, consider the following web service security message:

<soap:Envelope>
<soap:Header>

<wsse:Security>

<wsse:BinarySecurityToken

ValueType=“X509v3” wsu:Id=“X509Token”

EncodingType=“Base64Binary”>

MIIEZzCCA9CgAwIBAgIQEmtJZcOrqrKh5i...

</wsse:BinarySecurityToken>
<ds:Signature>

<ds:SignedInfo>

<ds:CanonicalizationMethod Algorithm=“xml-exc-c14n”/>
<ds:SignatureMethod Algorithm=“ rsa-sha1”/>
<ds:Reference URI=“#body”>

<ds:Transforms>

<ds:Transform Algorithm=“ xml-exc-c14n”/>

</ds:Transforms>
<ds:DigestMethod Algorithm=“sha1”/>
<ds:DigestValue>LyLsF094hPi4wPU...</ds:DigestValue>

</ds:Reference>

</ds:SignedInfo>
<ds:SignatureValue>

Hp1ZkmFZ/2kQLXDJbchm5gK...

</ds:SignatureValue>
<ds:KeyInfo>

<wsse:SecurityTokenReference>
<wsse:Reference URI=“#X509Token”/>
</wsse:SecurityTokenReference>

</ds:KeyInfo>

</ds:Signature>

</wsse:Security>

</soap:Header>
<soap:Body wsu:Id=“body”>

<tru:StockSymbol xmlns:tru=“http://fabrikam123.com/payloads”>

QQQ

</tru:StockSymbol>

</soap:Body>
</soap:Envelope>

The exemplary web services security message above illustrates application data contained within the Body element specified by the XML tags <soap:Body> and </soap:Body> and security data contained within the Header element specified by the XML tags <soap:Header> and </soap:Header>. The Header element above includes a X.509 security token in the BinarySecurityToken element specified by the XML tags <wsse:BinarySecurityToken> and </wsse:BinarySecurityToken>. The Header element above also includes a digital signature in the Signature element specified by the XML tags <ds:Signature> and </ds:Signature>. The Signature element specifies the following information:
Body element is signed,
Signature Algorithm,
Transformation Algorithm,
Reference to a Key,
Digest Value, and
Signature Value.

To create and identify web service messages that have particular security features, a web service utilizes a security policy such as the web service security policy (106) stored in RAM (168) of the computing device (152) in FIG. 1. A web service security policy defines the security rules with which messages consumed or produced by a web service must comply. A web service security policy may be specified in an XML-document according the WS-SecurityPolicy specification development by International Business Machines Corporation, et al. WS-SecurityPolicy defines a number of sections that may be included in a security policy for integrity and confidentiality assertions, bindings, and supporting tokens. Integrity and confidentiality assertions indicate which particular parts of a web services message should be signed and encrypted, respectively. A binding specifies detailed information required to sign and encrypt some parts of messages such as signatures.

A binding also specifies encryption algorithms, security token information, and a layout for the elements in a web service message. Supporting tokens are additional tokens that are not described in a binding section.

Consider, for example, the following web service security policy used for verifying or generating the exemplary web service security message described above:

...
<sp:AsymmetricBinding>

<sp:InitiatorToken id=“initToken”>

<sp:X509Token.../>

</sp:InitiatorToken>
<sp:RecipientToken id=“recipToken”>

<sp:X509Token.../>

</sp:RecipientToken>
<sp:AlgorithmSuite>

<sp:Basic256/>

</sp:AlgorithmSuite>
<sp:Layout>

<sp:Strict/>

</sp:Layout>

</sp:AsymmetricBinding>
...
<sp:SignedParts>

<sp:Body/>

</sp:SignedParts>
...

The exemplary web service security policy above illustrates an integrity assertion using a ‘SignedParts’ element denoted by the XML tags <sp:SignedParts> and </sp:SignedParts>. The ‘SignedParts’ element requires that the Body element of a web service security message be signed. The exemplary web service security policy above also illustrates a binding section using an ‘AsymmetricBinding’ section denoted by the XML tags <sp:AsymmetricBinding> and </sp:AsymmetricBinding>. The ‘AsymmetricBinding’ section specifies that the Header element of a web service security message must include a X.509 certificate, that the ‘Basic256’ algorithm suite is used to sign and encrypt a security message, and that a ‘strict’ layout is used for arranging the elements in the security message. Readers will note that the exemplary web service security policy above omits logical operators such as, for example, ‘all’ or ‘ExactlyOne,’ for clarity. Logical operators useful in web service security policies may include those specified in WS-SecurityPolicy.

Because a security policy may be utilized in a variety of different runtime environments, the computing device (152) includes runtime configuration (107) stored in RAM (168). The runtime configuration (107) of FIG. 1 specifies information about the platform-specific environment used to implement the web service security policy (106). Consider, for example, that the web service security policy (106) specifies using a particular X.509 key for signing and encryption. The runtime configuration (107) may specify the particular key file and an ID/password combination for accessing the key file.

In the example of FIG. 1, the computing device includes a security policy profile (103) stored in RAM (168). Similar to a security policy, a security policy profile specifies rules or guidelines for implementing security in the exchange of messages between web services. As mentioned above, most enterprises have security guidelines in the form of security profiles to guide the development of security policies that described the format of Web services security messages. For example, an enterprise may decide that the Body element of a message will always be signed using an X.509 key and that the elements in security messages are arrange in a strict manner. In lieu of developing a proprietary security profile, there also exist industry standard profiles for Web services security such as, for example, WS-I Basic Security Profile that also prescribes industry standard security message formats. The guidelines of a security policy profile are used to develop the security policy used by a web service to identify whether web service messages comply with the security policy profile of an enterprise.

Also stored in RAM (168) of FIG. 1 is a policy validation module (102). The policy validation module (102) of FIG. 1 is computer software that determines whether a security policy is valid with respect to the rules of a security profile. The policy validation module (102) of FIG. 1 includes a set of computer program instructions for security policy validation for web services according to embodiments of the present invention. As discussed in more detail below, the policy validation module (102) of FIG. 1 operates generally for security policy validation for web services according to embodiments of the present invention by: transforming a security policy (106) for the web service (108) into a policy predicate logic representation (101); providing a profile predicate logic representation (104) that represents one or more rules of a security policy profile (103); and determining whether the security policy (106) satisfies the security policy profile (103) in dependence upon the policy predicate logic representation (101) and the profile predicate logic representation (104).

In addition to determining whether a security policy is valid with respect to the rules of a security profile, the policy validation module (102) may also determine whether a security policy is valid with respect to the runtime configuration for the runtime environment in which the policy is utilized. Such validation ensures that a security policy that calls for a X.509 key is deployed in an environment that in fact has an X.509 key. As such, the policy validation module (102) may also operate generally for security policy validation for web services according to embodiments of the present invention by: providing a runtime configuration predicate logic representation (105) that represents one or more configuration parameters of a runtime configuration environment (107); and determining whether the security policy (106) matches the runtime configuration environment (107) in dependence upon the policy predicate logic representation (101) and the runtime configuration predicate logic representation (105).

Also stored in RAM (168) is an operating system (154). Operating systems useful for applying firmware updates to servers in a data center according to embodiments of the present invention include UNIX™, Linux™, Microsoft XP™, AIX™, IBM's i5/OS™, and others as will occur to those of skill in the art. The operating system (154), the web service (108), web service security policy (106), the security policy profile (103), the policy predicate logic representation (101), the profile predicate logic representation (104), the runtime configuration (107), the runtime configuration predication logic representation (105), and the policy validation module (102) in the example of FIG. 1 are shown in RAM (168), but many components of such software typically are stored in non-volatile memory also, such as, for example, on a disk drive (170).

The computing device (152) of FIG. 1 includes disk drive adapter (172) coupled through expansion bus (160) and bus adapter (158) to processor (156) and other components of the computing device (152). Disk drive adapter (172) connects non-volatile data storage to the computing device (152) in the form of disk drive (170). Disk drive adapters useful in computing devices for security policy validation for web services according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory) (134), RAM drives, and so on, as will occur to those of skill in the art.

The example computing device (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computing device (152) of FIG. 1 includes a video adapter (309), which is an example of an I/O adapter specially designed for graphic output to a display device (180) such as a display screen or computer monitor. Video adapter (309) is connected to processor (156) through a high speed video bus (164), bus adapter (158), and the front side bus (162), which is also a high speed bus.

The exemplary computing device (152) of FIG. 1 includes a communications adapter (167) that couples the computing device for data communications with other servers in the data center through a data communications network (100). Such a data communication network (100) may be implemented with external buses such as a Universal Serial Bus (‘USB’), or as an Internet Protocol (‘IP’) network or an Ethernet™ network, an I²C network, a System Management Bus (‘SMBus’), an Intelligent Platform Management Bus (‘IPMB’), for example, and in other ways as will occur to those of skill in the art. Communications adapters implement the hardware level of data communications through which one computer sends data communications to another computer, directly or through a data communications network. Examples of communications adapters useful for security policy validation for web services according to embodiments of the present invention include modems for wired dial-up communications, Ethernet (IEEE 802.3) adapters for wired data communications network communications and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

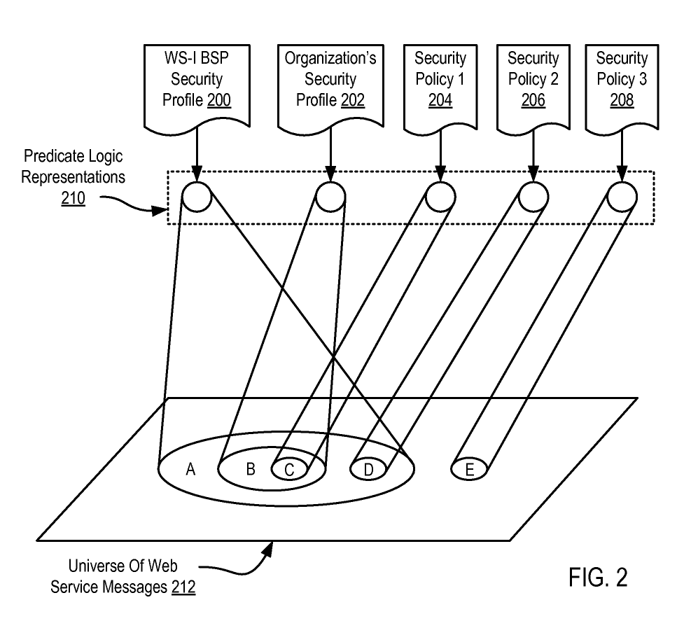

For further explanation, FIG. 2 sets forth a line drawing illustrating exemplary security policies and security profiles useful in security policy validation for web services according to embodiments of the present invention. FIG. 2 illustrates a security profile (200) that describes security features of web service security messages according to the WS-I Basic Security Profile (‘BSP’) specification and illustrates a security profile (202) that describes security features of web service security messages according an organization's own proprietary security guidelines. FIG. 2 also illustrates three security policies (204, 206, 208) that specify security features for security messages produced or consume by a web service. The security policies (204, 206, 208) of FIG. 2 may be implemented according to, for example, WS-SecurityPolicy specification.

In the example of FIG. 2, the security profiles (200, 202) and the security policies (204, 206, 208) are transformed into predicate logic representations (210). A predicate logic representation of a security policy specifies the relationship between a security policy and a web service message, that is, whether a web service message conforms to the particular security policy. Similarly, the predicate logic representation of a security profile specifies the relationship between a security profile and a web service message, that is, whether a web service message comports with the particular security profile. In such a manner, the predicate logic representations (210) of FIG. 2 map the security profiles (200, 202) and the security policies (204, 206, 208) to the universe (212) of web service messages. The predicate logic representation of the WS-I BSP security profile (200) specifies that all of the messages in subset ‘A’ of the message universe (212) comport with the WS-I BSP security profile (200). The predicate logic representation of the Organization's proprietary security profile (202) specifies that all of the messages in subset ‘B’ of the message universe (212) comport with the Organization's proprietary security profile (202). The predicate logic representation of security policy 1 (204) specifies that all of the messages in subset ‘C’ of the message universe (212) conform to security policy 1 (204). The predicate logic representation of security policy 2 (206) specifies that all of the messages in subset ‘D’ of the message universe (212) conform to security policy 2 (206). The predicate logic representation of security policy 3 (208) specifies that all of the messages in subset ‘D’ of the message universe (212) conform to security policy 3 (208).

As mentioned above, software architects use the guidelines of an organization's own proprietary security profile or an industry standard security profile such as WS-I BSP to develop a security policy used by a web service. As illustrated in FIG. 2, a policy validation module may determine whether the security policy satisfies the security policy profile in dependence upon predicate logic representation for the policy and the predicate logic representation for the profile by determining whether a web service message exists that satisfies the policy predicate logic representation and that does not satisfy profile predicate logic representation. For example, consider whether the security policies 1, 2, and 3 (204, 206, 208) are valid with respect to the WS-I BSP security profile (200) and the Organization's own proprietary security profile (202). FIG. 2 illustrates that security policy 1 (204) and security policy 2 (206) satisfy the WS-I BSP security profile (200) because both message subsets ‘C’ and ‘D’ are within the message subset ‘A.’ FIG. 2 illustrates that security policy 3 (208) does not satisfy the WS-I BSP security profile (200) because the message subset ‘E’ is not within the message subset ‘A.’ FIG. 2 illustrates that security policy 1 (204) satisfies the Organization's own proprietary security profile (202) because the message subset ‘C’ is within the message subset ‘B.’ FIG. 2 illustrates that security policy 2 (206) and security policy 3 (208) do not satisfy the Organization's own proprietary security profile (202) because neither the message subset ‘D’ nor the message subset ‘E’ is within the message subset ‘B.’

As mentioned above, the security profiles (200, 202) and the security policies (204, 206, 208) are represented as predicate logic representations (210) in the example of FIG. 2. The predicate logic representations (210) may be implemented using Prolog. Prolog is a high-level programming language based on predicate logic. Unlike traditional programming languages that are based on performing sequences of commands, Prolog is based on defining and then solving logical formulas. Prolog is sometimes called a declarative language or a rule-based language because its programs comprise lists of facts and rules. Facts and rules comprising Prolog programs are often stored in program files referred to as Prolog databases. A Prolog database comprising factual assertions and logical rules is correctly viewed as a knowledge base or rules base. In this disclosure, the utilization of Prolog is exemplary, not a requirement of the present invention. In addition to Prolog, many methods and means, and many computer languages, will occur to those of skill in the art for establishing rules bases, and all such methods, means, and languages are well within the scope of the present invention.

Facts and rules in Prolog are typically arranged in predicate logic form. For example, the following is an exemplary set of three Prolog clauses:

parent(fred, greta).
parent(greta, henry).
grandparent(X, Z) :- parent(X, Y), parent(Y, Z).

Prolog clauses are normally of three types: Facts declare things that are true. Rules declare things that are true depending on a given condition. Questions are used to find out if a particular rule is presently satisfied by asserted facts, when the rule is said to be ‘true.’ Prolog questions are sometimes referred to as ‘goals’ or ‘queries.’ In the three-line example above, “parent(fred, greta) is a fact. “Parent” is a predicate. “Fred” is the first argument, sometimes called a ‘subject.’ “Greta” is the second argument, sometimes called an ‘object.’

In the three-line example above, “grandparent(X, Z):-parent(X, Y), parent(Y, Z).” is a rule. “Grandparent(X, Z)” is referred to as the ‘head’ of the rule. “Parent(X, Y), parent(Y, Z)” is referred to as the ‘body’ of the rule. “Parent(X, Y)” is the first subgoal of the rule. “Parent(Y, Z)” is the second subgoal of the rule. X, Y, and Z are variables.

This example rule is correctly described in several ways. One declarative description is: For all X and Z, X is a grandparent of Z if there exists some Y such that X is a parent of Y and Y is a parent of Z. Another declarative description is: For all X, Y and Z, if X is a parent of Y and Y is a parent of Z then X is a grandparent of Z. A procedural interpretation of the rule is: The goal grandparent(X, Z) succeeds with binding X1 for X and binding Z1 for Z if first, the goal parent(X, Y) succeeds with bindings X1 and Y1 and then the goal parent(Y, Z) succeeds with bindings Y1 and Z1.

A Prolog goal is said to ‘succeed’ if it can be satisfied from a set of clauses in a Prolog database. A goal fails if it cannot be so satisfied. For an example based upon the three-line set of example Prolog clauses set forth above: the query “grandparent(fred, X).” is satisfied with X instantiated to henry. On the other hand, the query “grandparent(fred, bob).” is not capable of being satisfied from the three-line exemplary Prolog database, because ‘bob’ does not appear in that set of clauses.

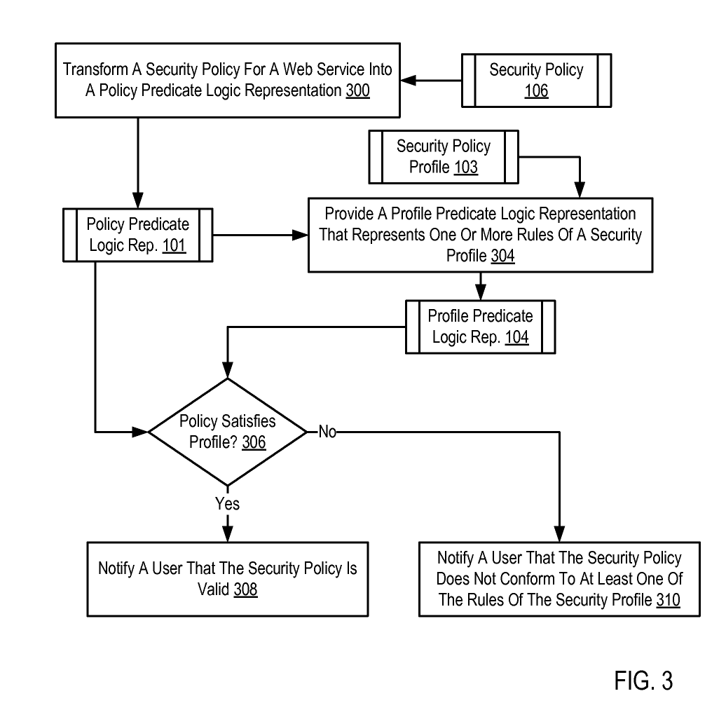

For further explanation, FIG. 3 sets forth a flow chart illustrating an exemplary method of security policy validation for web services according to embodiments of the present invention. The method of FIG. 3 includes transforming (300) a security policy (106) for a web service into a policy predicate logic representation (101). The security policy (106) of FIG. 3 represents a set of security rules with which messages consumed or produced by a web service must comply. The policy predicate logic representation (101) of FIG. 3 specifies the relationship between a security policy (106) and a web service message, that is, whether a web service message conforms to the security policy (106). For example, consider the following policy predicate logic representation of the exemplary security policy described above:

01: myPolicy(E):-

| | |
|---|---|
| 02: | E=env(H,B), |
| 03: | H=h(Sec), |
| 04: | Sec= |
| 05: | sec( |

| | |
|---|---|
| 06: | bst(‘@ValueType’(‘#X509v3’), |
| 07: | ‘@EncodingType’(‘#Base64Binary’), |
| 08: | ‘@id’(TokenID), |
| 09: | bstValue), |
| 10: | sig( |
| 11: | sigInfo( |
| 12: | c14nMethod(‘@Algorithm’(‘xml-exc-c14n#’)), |
| 13: | sigMethod(‘@Algorithm’(‘xmldsig#rsa-sha1’)), |
| 14: | ref(‘@URL’(BodyID), |

| | |
|---|---|
| 15: | transforms( |

| | |
|---|---|
| 16: | transform( |
| 17: | ‘@Algorithm’(‘xml-exc-c14n#’)), |
| 18: | digestMethod(‘@Algorithm’(‘xmldsig#sha1’)), |
| 19: | digestValue(dVal))), |

| | |
|---|---|
| 20: | sigValue(sVal), |
| 21: | keyInfo( |

| | |
|---|---|
| 22: | str(reference(‘@URI’(TokenID))))))), |

| | |
|---|---|
| 23: | B=body(‘@id’(BodyID),bodyValue). |

The Prolog rule illustrated above in lines 01-23 is used to implement the policy predicate logic representation for the exemplary security policy described above with reference to FIG. 1. ‘myPolicy(E)’ in line 01 serves as the head of the Prolog rule and everything in lines 02-23 serve as the body of the Prolog rule. The ‘E’ variable in line 01 represents a web service message. The Prolog rule illustrated above specifies that all web service messages that conform to the goals in the body of the Prolog rule also conform to the security policy ‘myPolicy.’ That is, if each of the goals in lines 02-23 of the Prolog rule above is true for a particular web service message, then it is true that the web service message conforms to the security policy ‘myPolicy.’

Transforming (300) a security policy (106) for a web service into a policy predicate logic representation (101) according to the method of FIG. 3 may be carried out by transforming a security policy (106) for a web service into a policy predicate logic representation (101) in dependence upon primitive rules, structure rules, and merging rules. Primitive rules are transformation rules that provide instructions for transforming a fragment of a security policy into a fragment of a policy predicate logic representation. For example, a primitive rule may provide the instructions for transforming the following security policy fragment:

<sp:SignedParts>

<sp:Body/>

</sp:SignedParts>

into the following fragment of a policy predicate logic representation:

sig(
sigInfo(
c14nMethod(@Algorithm($[c14n]),
sigMethod(@Algorithm($[sigMethod])),
ref(@URL(BodyID),

transforms(

transform(@Algorithm($[transform])),
digestMethod(@Algorithm($[digest])),
digestValue(***))),

sigValue(***),
keyInfo(

str(Reference(@URI(***)))))

and into the following addition fragment of a policy predicate logic representation:

body(@id(BodyID))

In the example above, because the ‘SignedParts’ element in the security policy fragment requires a signature element in the message, the ‘sig’ policy predicate logic representation fragment above also specifies that a message requires a signature element. Moreover, because the ‘SignedParts’ element in the security policy fragment specifies that the Body of the message is signed, the ‘body’ policy predicate logic representation fragment above specifies that a message requires a Body element. For further example, a primitive rule may provide the instructions for transforming the following security policy fragment:

<sp:EncryptedParts>

<sp:Body/>

</sp:EncryptedParts>

into the following fragment of a policy predicate logic representation:

encKey(

encMethod(@Algorithm(***)),
keyInfo(str(Reference(@URI(***)))),
cipherData(cipherValue(***),
refList(dataRef(@URI(enc1))))

and into the following addition fragment of a policy predicate logic representation:

encData(@Type(...#Element), @Id(enc1)),

encMethod(@Algorithm(***)),
cipherData(cipherValue(***)))

In the example above, because the ‘EncryptedParts’ element in the security policy fragment requires that the Body element of a message be encrypted, the ‘encKey’ and the ‘encData’ policy predicate logic representation fragments above specify encryption key information and encryption data information that is required in a web service message.

For further example, a primitive rule may provide the instructions for transforming the following security policy fragment:

<sp:X509Token sp:IncludeToken=“AlwaysToRecipt”>

<sp:WssX509V3Token10/>

</sp:X509Token>

into the following fragment of a policy predicate logic representation:

bst(@ValueType(...#X509v3), @EncodingType(...#Base64Binary),

@id(X509Token), BstVal)

In the example above, a primitive rule is used to transform the security policy fragment that requires an X.509 security token for the signed portion of the message into a ‘bst’ policy predicate logic representation fragment that specifies a message should have an X.509 binary signature token (‘bst’).

For further example, a primitive rule may provide the instructions for transforming the following security policy fragment:

<sp:UsernameToken sp:IncludeToken=“AlwaysToRecipt”>

<sp:WssUsernameToken10/>

</sp:UsernameToken>

into the following fragment of a policy predicate logic representation:

usernametoken(

un(ID),
pwd(PWD))

In the example above, a primitive rule is used to transform the security policy fragment that requires a username security token for the signed portion of the message into a ‘usernametoken’ policy predicate logic representation fragment that specifies a message should have a username/password combination.

For further example, a primitive rule may provide the instructions for transforming the following security policy fragment:

<sp:MustSupportRefKeyIdentifier/>

into the following fragment of a policy predicate logic representation:

keyID(EncordingType(***), @ValueType(***), keyIdentifier).

In the example above, a primitive rule is used to transform the security policy fragment that requires a web service message to support a reference token identifier into a ‘keyID’ policy predicate logic representation fragment that specifies a message should specify a reference key identifier.

For further example, a primitive rule may provide the instructions for transforming the following security policy fragment:

<sp:MustSupportRefIssuerSerial/>

into the following fragment of a policy predicate logic representation:

STR(

X509IssuerSerial(

X509IssuerName(DName),
X509SerialNumber(sNumber))).

In the example above, a primitive rule is used to transform the security policy fragment that requires a web service message to support a reference to a token issuer into a ‘STR’ policy predicate logic representation fragment that specifies a message should specify an X.509 issuer.

For further example, a primitive rule may provide the instructions for transforming the following security policy fragment:

<sp:MustSupportRefEmbeddedToken/>

into the following fragment of a policy predicate logic representation:

STR(Embedded(@id(***), ***)).

In the example above, a primitive rule is used to transform the security policy fragment that requires a web service message to support a reference to an embedded token into a ‘STR’ policy predicate logic representation fragment that specifies a message should specify an identifier for an embedded security token. Readers will note that the policy predicate logic representation fragments above generated by primitive rules from the security policy fragments are fragments of a Prolog rule. The Prolog rule fragments above are illustrated for explanation and not for limitation. Primitive rules may be used to transform a security policy fragments into other forms of policy predicate logic representation fragments as will occur to those of skill in the art.

Structure rules are transformation rules that express the message element structure requirements of the security policy (106) into the policy predicate logic representation (101). For example, a ‘Layout’ element in a security policy defines the order of elements in a SOAP message header, and an ‘EncryptBeforeSigning’ element in a security policy requires that encryption must be performed before signing.

Merging rules are transformation rules that define how to merge the policy predicate logic representation fragments created by primitive rules into a single policy predicate logic representation. Using only primitive rules and structure rules, the constructed policy predicate logic representation may have redundant elements or may lack necessary associations between elements. Consider, for example, the following portion of a web service security policy:

<sp:AsymmetricBinding>

<sp:InitiatorToken>

<sp:X509Token sp:IncludeToken=“AlwaysToRecpt”>

<sp:WssX509V3Token10/>

</sp:X509Token>

</sp:InitiatorToken>
<sp:AlgorithmSuite>

<sp:Basic256/>

</sp:AlgorithmSuite>

</sp:AsymmetricBinding>
<sp:SignedParts>

<sp:Body/>

</sp:SignedParts>

and the following portion of its corresponding policy predicate logic representation:

bst(@ValueType(...#X509v3),

@EncodingType(...#Base64Binary),
@id(X509Token), BstVal),

...
sig(

sigInfo(
c14nMethod(@Algorithm(.../xml-exc-c14n#)),
sigMethod(@Algorithm(.../xmldsig#rsa-sha1)),
ref(@URL(BodyID),

transforms(

transform(@Algorithm(.../xml-exc-c14n#))),
digestMethod(@Algorithm(.../xmldsig#sha1)),
digestValue(dVal)))

sigValue(sVal),
keyInfo(str(Reference(@URI(#X509Token)))))

...
body(@id(BodyID))

Using primitive rules, the ‘X509Token’ element and the ‘SignedParts’ element are transformed into the ‘bst’ element and the ‘sig’ element, respectively. In applying a merger rule, readers will note that the ‘Basic256’ identifier under the ‘AlgorithmSuite’ element in the security policy is used to specify an algorithm for the signature. As such, a merger rule in the example above associates the X.509 token with the ‘sig’ element, applying the rule that the signature element created by ‘SignedParts’ element must refer to a token specified in the ‘InitiatorToken’ element.

The method of FIG. 3 also includes providing (304) a profile predicate logic representation (104) that represents one or more rules of a security policy profile (103). The security policy profile (103) of FIG. 3 specifies rules or guidelines for implementing security in the exchange of messages between web services. The security policy profile (103) may be implemented using an organization's own proprietary set of security guidelines, an industry standard set of security guidelines such as, for example, the WS-I Basic Security Profile specification, or any other implementation as will occur to those of skill in the art. The profile predicate logic representation (104) of FIG. 3 specifies the relationship between the security profile (103) and a web service message, that is, whether a web service message comports with the security profile (103). For further explanation, consider the following guideline regarding security token substation in a security profile implemented according to the WS-I Basic Security Profile specification:

| | |
|---|---|
| C5443: | When the signer's SECURITY_TOKEN is an |
| | INTERNAL_SECURITY_TOKEN, the SIGNED_INFO MAY |
| | include a SIG_REFERENCE that refers to the signer's |
| | SECURITY_TOKEN in order to prevent substitution with |
| | another SECURITY_TOKEN that uses the same key. |

A software architect may provide the following profile predicate logic representation of the exemplary security profile rule above:

| 01: c5443(E):- | |
|---|---|
| 02: | ... |
| 03: | sec( |

| | |
|---|---|
| 04: | sig(... |

| | |
|---|---|
| 05: | ref(‘@URL’(BodyID),...) |
| 06: | ref(‘@URL’(TokenID),...) |
| 07: | ...), |

| | |
|---|---|
| 08: | B=body(‘@id’(BodyID),bodyValue). |

The exemplary security profile rule above in lines 01-08 is implemented as a Prolog rule. ‘c5443(E)’ in line 01 serves as the head of the Prolog rule and everything in lines 02-08 serve as the body of the Prolog rule. The Prolog rule illustrated above specifies that all web service messages that conform to the goals in the body of the Prolog rule, namely that the signature includes signature reference that refers to the signer's security token, also conform to the security profile rule ‘c5443.’ That is, if each of the goals in lines 02-08 of the Prolog rule above is true for a particular web service message, then it is true that the web service message conforms to the security profile rule ‘c5443.’

The method of FIG. 3 also includes determining (306) whether the security policy (106) satisfies the security policy profile (103) in dependence upon the policy predicate logic representation (101) and the profile predicate logic representation (104). Determining (306) whether the security policy (106) satisfies the security policy profile (103) according to the method of FIG. 3 may be carried out by determining whether a web service message exists that satisfies the policy predicate logic representation (101) and that does not satisfy profile predicate logic representation (104). Determining whether a web service message exists that satisfies the policy predicate logic representation (101) and that does not satisfy profile predicate logic representation (104) may be carried out by executing a Prolog expression using the policy predicate logic representation (101) and the profile predicate logic representation (104). Consider, for example, the exemplary the policy predicate logic representation ‘myPolicy’ and the exemplary profile predicate logic representation ‘c5443.’ Using these exemplary representations, executing the following Prolog expression evaluates to true or false:

myPolicy(E),˜c5443(E)

The exemplary Prolog expression above evaluates to true if a web service message ‘E’ exists that does not satisfy the ‘c5443’ security profile rule but does satisfy the ‘myPolicy’ security policy. The exemplary Prolog expression above evaluates to false if no web service message ‘E’ exists that does not satisfy the ‘c5443’ security profile rule but does satisfy the ‘myPolicy’ security policy. If the expression ‘myPolicy(E),˜c5443(E)’ evaluates to false, therefore, then the security policy (106) satisfies the security policy profile (103). The security policy (106) does not satisfy the security policy profile (103), however, if the expression ‘myPolicy(E),˜c5443(E)’ evaluates to true. As discussed in more detail below, when the security policy (106) does not satisfy the security policy profile (103), Prolog may provide an example of a web service message satisfying the expression ‘myPolicy(E),˜c5443(E),’ thereby providing a policy developer with an example message demonstrating that the security policy (106) does not satisfy the security policy profile (103). The policy developer may utilize such an exemplary message to identify why the security policy (106) does not satisfy the security policy profile (103). From the discussion above, readers will note that after the security policy (106) and the security profile (103) are represented in predicate logic representations, then determining (306) whether the security policy (106) satisfies the security policy profile (103) may be carried out merely by evaluating a predicate logic expression using the representations.

The method of FIG. 3 also includes notifying (308) a user that the security policy is valid if the security policy (106) satisfies the security policy profile (103). Notifying (308) a user that the security policy is valid according to the method of FIG. 3 may be carried out by rendering, to the user, a notification on a graphical user interface (‘GUI’) that the security policy (106) comports with the security policy profile (103).

The method of FIG. 3 also includes notifying (310) a user that the security policy (106) does not conform to at least one of the rules of the security policy profile (103) if the security policy (106) does not satisfy the security policy profile (103). Notifying (310) a user that the security policy (106) does not conform to at least one of the rules of the security policy profile (103) according to the method of FIG. 3 may be carried out by rendering, to the user, a notification on a GUI that the security policy (106) does not comport with the security policy profile (103). Notifying (310) a user that the security policy (106) does not conform to at least one of the rules of the security policy profile (103) according to the method of FIG. 3 may also be carried out by providing the user with an example of a message demonstrating that the security policy (106) does not satisfy the security policy profile (103). For example, consider again the exemplary Prolog expression above:

myPolicy(E),˜c5443(E)

If the Prolog expression above evaluates to true, then Prolog returns an instance of a web service message ‘E’ that satisfies the expression. That is, Prolog returns an example message that does not satisfy the ‘c5443’ security profile rule but does satisfy the ‘myPolicy’ security policy. Such an example of a message demonstrating that the security policy (106) does not satisfy the security policy profile (103) may be useful to a software architect in modifying the security policy (106) to comport with the security policy (103).

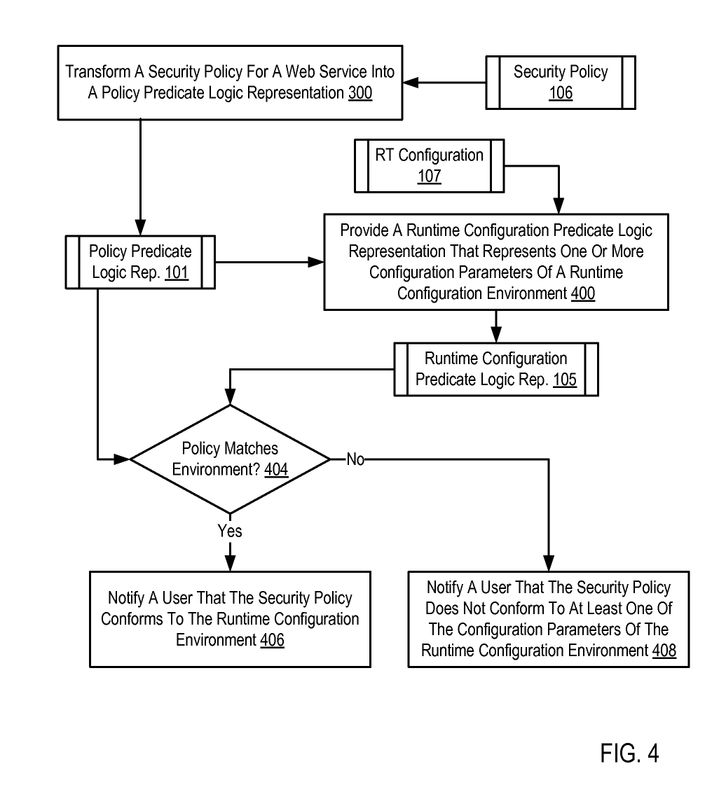

The explanation above with reference to FIG. 3 describes security policy validation for web services according to embodiments of the present invention with respect to the rules of a security profile. As mentioned above, security policy validation for web services according to embodiments of the present invention may also be performed with respect to the runtime configuration for the runtime environment in which the policy is utilized. Such validation ensures, for example, that a security policy that calls for a X.509 key is deployed in an environment that in fact has an X.509 key. For further explanation, FIG. 4 sets forth a flow chart illustrating a further exemplary method of security policy validation for web services according to embodiments of the present invention. The method of FIG. 4 includes transforming (300) a security policy (106) for a web service into a policy predicate logic representation (101). Transforming (300) a security policy (106) for a web service into a policy predicate logic representation (101) according to the method of FIG. 4 is carried out in a manner similar to the manner described above with reference to FIG. 3.

The method of FIG. 4 also includes providing (400) a runtime configuration predicate logic representation (105) that represents one or more configuration parameters of a runtime configuration environment (107). The runtime configuration environment (107) of FIG. 4 specifies information about the platform-specific environment used to implement a particular web service. The runtime configuration predicate logic representation (105) of FIG. 4 specifies the relationship between the runtime configuration environment (107) and a web service message, that is, whether the runtime configuration environment supports the web service message. For example, consider the following runtime configuration predicate logic representation for a particular runtime configuration environment:

| 01: RTEnvironment(E):- | |
|---|---|
| 02: | E=env(H,B), |
| 03: | H=h(Sec), |

| | |
|---|---|
| 04: | Sec= sec(...) |

| | |
|---|---|
| 05: | B=body(...). |

The exemplary runtime configuration predicate logic representation above in lines 01-05 is implemented as a Prolog rule. ‘RTEnvironment(E)’ in line 01 serves as the head of the Prolog rule and everything in lines 02-05 serve as the body of the Prolog rule. The Prolog rule illustrated above describes all web service messages ‘E’ that are supported by a particular runtime configuration environment. That is, the rule ‘RTEnvironment(E)’ is true for all messages that are supported by the particular runtime configuration environment, and the rule ‘RTEnvironment(E)’ is false for all messages that are not supported by the particular runtime configuration environment.

The method of FIG. 4 includes determining (404) whether the security policy (106) matches the runtime configuration environment (107) in dependence upon the policy predicate logic representation (101) and the runtime configuration predicate logic representation (105). Determining (404) whether the security policy (106) matches the runtime configuration environment (107) according to the method of FIG. 4 may be carried out by determining whether a message exists that is not supported by the runtime configuration environment (107) but does satisfy the security policy (106). Determining whether a message exists that is not supported by the runtime configuration environment (107) but does satisfy the security policy (106) may be carried out by executing a Prolog expression using the policy predicate logic representation (101) and the runtime configuration predicate logic representation (105). Consider, for example, the exemplary the policy predicate logic representation ‘myPolicy’ and the exemplary runtime configuration predicate logic representation ‘RTEnvironment.’ Using these exemplary representations, executing the following Prolog expression evaluates to true or false:

myPolicy(E),˜RTEnvironment(E)

The exemplary Prolog expression above evaluates to true if a web service message ‘E’ exists that is not supported by a runtime environment represented by ‘RTEnvironment’ but does satisfy the ‘myPolicy’ security policy. The exemplary Prolog expression above evaluates to false if a web service message ‘E’ does not exist that is not supported by a runtime environment represented by ‘RTEnvironment’ but does satisfy the ‘myPolicy’ security policy. If the Prolog expression ‘myPolicy(E),˜RTEnvironment(E)’ evaluates to false, therefore, then the security policy (106) matches the runtime configuration environment (107). The security policy (106) does not match the runtime configuration environment (107), however, if the Prolog expression ‘myPolicy(E),˜RTEnvironment(E)’ evaluates to true. Readers will note that after the security policy (106) and the runtime configuration environment (107) are represented in predicate logic representations, then determining (404) whether the security policy (106) matches the runtime configuration environment (107) may be carried out merely by evaluating a predicate logic expression using the representations.

The method of FIG. 4 includes notifying (406) a user that the security policy (106) conforms to the runtime configuration environment (107) if the security policy (106) matches the runtime configuration environment (107). Notifying (406) a user that the security policy (106) conforms to the runtime configuration environment (107) according to the method of FIG. 4 may be carried out by rendering, to the user, a notification on a graphical user interface (‘GUI’) that the security policy (106) conforms to the runtime configuration environment (107).

The method of FIG. 4 notifying (408) a user that the security policy (106) does not conform to at least one of the configuration parameters of the runtime configuration environment (107) if the security policy (106) does not match the runtime configuration environment (107). Notifying (408) a user that the security policy (106) does not conform to at least one of the configuration parameters of the runtime configuration environment (107) according to the method of FIG. 4 may be carried out by rendering, to the user, a notification on a GUI that the security policy (106) does not conform to at least one of the configuration parameters of the runtime configuration environment (107). Notifying (408) a user that the security policy (106) does not conform to at least one of the configuration parameters of the runtime configuration environment (107) according to the method of FIG. 4 may also be carried out by providing the user with an example of a message demonstrating that the security policy (106) does not conform to at least one of the configuration parameters of the runtime configuration environment (107). For example, consider again the exemplary Prolog expression above:

myPolicy(E),˜RTEnvironment(E)

If the Prolog expression above evaluates to true, then Prolog returns an instance of a web service message that satisfies the expression. That is, Prolog returns an example message that is not supported by the runtime environment represented by ‘RTEnvironment’ but does satisfy the ‘myPolicy’ security policy. Such an example of a message demonstrating that the security policy (106) does not conform to at least one of the configuration parameters of the runtime configuration environment (107) may be useful to a software architect in modifying either the security policy (106) or the runtime configuration environment (107).

Exemplary embodiments of the present invention are described largely in the context of a fully functional computer system for security policy validation for web services. Readers of skill in the art will recognize, however, that the present invention also may be embodied in a computer program product disposed on a computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of security policy validation for web services, the method comprising:
transforming a security policy for a web service into a policy predicate logic representation;
providing a profile predicate logic representation that represents one or more rules of a security policy profile;
determining whether the security policy satisfies the security policy profile in dependence upon the policy predicate logic representation and the profile predicate logic representation; and
notifying a user that the security policy is valid if the security policy satisfies the security policy profile.

2. The method of claim 1 wherein transforming a security policy for a web service into a policy predicate logic representation further comprises transforming a security policy for a web service into a policy predicate logic representation in dependence upon primitive rules, structure rules, and merging rules.

3. The method of claim 1 wherein determining whether the security policy satisfies the security policy profile in dependence upon the policy predicate logic representation and the profile predicate logic representation further comprises determining whether a web service message exists that satisfies the policy predicate logic representation and that does not satisfy profile predicate logic representation.

4. The method of claim 1 further comprising notifying a user that the security policy does not conform to at least one of the rules of the security policy profile if the security policy does not satisfy the security policy profile.

5. The method of claim 1 further comprises:
providing a runtime configuration predicate logic representation that represents one or more configuration parameters of a runtime configuration environment; and
determining whether the security policy matches the runtime configuration environment in dependence upon the policy predicate logic representation and the runtime configuration predicate logic representation.

6. The method of claim 5 further comprises notifying a user that the security policy does not conform to at least one of the configuration parameters of the runtime configuration environment if the security policy does not match the runtime configuration environment.

7. The method of claim 5 further comprises notifying a user that the security policy conforms to the runtime configuration environment if the security policy matches the runtime configuration environment.

8. A method of security policy validation for web services, the method comprising:
transforming a security policy for a web service into a policy predicate logic representation in dependence upon primitive rules, structure rules, and merging rules;
providing a profile predicate logic representation that represents one or more rules of a security policy profile;
determining whether the security policy satisfies the security policy profile in dependence upon the policy predicate logic representation and the profile predicate logic representation, including determining whether a web service message exists that satisfies the policy predicate logic representation and that does not satisfy profile predicate logic representation;
notifying a user that the security policy does not conform to at least one of the rules of the security policy profile if the security policy does not satisfy the security policy profile;
providing a runtime configuration predicate logic representation that represents one or more configuration parameters of a runtime configuration environment;
determining whether the security policy matches the runtime configuration environment in dependence upon the policy predicate logic representation and the runtime configuration predicate logic representation; and
notifying a user that the security policy does not conform to at least one of the configuration parameters of the runtime configuration environment if the security policy does not match the runtime configuration environment.
